(19) United States
(12) Patent Application Publication
(10) Pub. No.: US 2026/0096550 A1
(43) Pub. Date: Apr. 9, 2026

(54) ACCURATE APPLICATION OF LIQUIDS IN A FIELD FOR CROP PLANTS

(71) Applicant: BAYER AKTIENGESELLSCHAFT, Leverkusen (DE)

(72) Inventors: Matthias TEMPEL, Leverkusen (DE); Walter MAYER, Leverkusen (DE)

(21) Appl. No.: 19/114,119

(22) PCT Filed: Sep. 18, 2023
(86) PCT No.: PCT/EP2023/075594

§ 371 Date: Mar. 21, 2025

(30) Foreign Application Priority Data
Sep. 22, 2022 (EP) 22197104.7

(51) Int. Cl. A01M 7/00

(52) U.S. Cl. CPC A01M 7/0089; A01M 7/0042; A01M 7/0067

(57) ABSTRACT

The present invention relates to the technical field of precision agriculture. The invention relates to a method and a system for accurate application of a liquid in a field for crop plants.

The present disclosure relates to the technical field of precision farming. The present invention relates to a system and a method for precisely applying a liquid in a field for crop plants.

Precision farming is the term used to describe methods for the spatially-differentiated and targeted management of agricultural land areas.

Using remote sensing data and/or sensors within a field and/or sensors on processing machines moving in the field, a variety of properties can be acquired with high spatial resolution for various sub-regions in an agricultural region, such as crop yield, terrain features/topography, organic matter content, moisture, nitrogen content, pH value, soil composition, weed distribution and much more.

In addition, measures can be carried out specifically in sub-regions or even on individual plants in the field.

US20210299692A1 discloses, for example, an agricultural sprayer comprising a sensor for plant features. The sprayer is configured to apply plant protection agents specifically to components of plants identified by means of the sensor for plant features.

US20220117151A1 discloses a method for applying a liquid to a field, in which the position of each individual nozzle of an agricultural sprayer is determined. A defined flow rate is determined for each of the nozzles based on the position of the respective nozzle in the field. Use is made of a field map containing information on the needs of the plants and the application restrictions. The flow rate for each nozzle is determined based on a comparison of the position of the nozzle with the field map.

When applying liquids in a field for crop plants, valves controlled with pulse-width modulation (PWM) are often used. These are usually installed in front of each nozzle. During pulse-width modulation, a square-wave voltage signal with a defined period duration is generated. The valves are therefore switched on and off in rapid succession. The ratio of ON time to OFF time is varied and determines the mean valve flow rate. Thus, the flow rate can be controlled independently of the pressure. The quantity can be adjusted individually at each nozzle. The use of valves controlled with pulse-width modulation in the agricultural sector is described, for example, in: WO2020/245025A1, WO2008/112930A1, U.S. Pat. No. 9,635,848 and DE102018208156A.

There is the need to apply liquids in a field for crop plants with increasing accuracy in order to conserve resources, increase the efficiency of the applied agents and prevent application in undesirable regions. For example, in the control of accompanying plants that grow in a field in addition to the crop plants, there is the need to treat only the accompanying plants with a herbicide and not to apply a herbicide to crop plants or to the arable soil between the plants.

Such an increasing spatial accuracy during application can be achieved by a large number of nozzles which are installed close to each other. However, equipping each individual nozzle with valves controlled with pulse-width modulation in the case of a large number of nozzles would mean a considerable investment.

DE102018221442A1 and US2019232304A1 suggest installing a three-way valve in front of the nozzle outlet. Depending on the position of the three-way valve, a liquid is conveyed through the nozzle outlet in the direction of a target object or the liquid is returned to a storage container through a return line. There is a pressure in front of each nozzle outlet in order to convey liquid through the nozzle outlet. Switching the three-way valve back and forth in a pressurized line causes pressure fluctuations within the connected lines. If a three-way valve in front of a nozzle outlet is switched, this can cause pressure fluctuations at adjacent nozzle outlets. The pressure fluctuations can cause liquid to leak unevenly from adjacent open nozzle outlets.

These and other problems are solved by the subjects of the independent claims. Preferred embodiments are found in the dependent claims, the present description and the drawings.

A first subject of the present invention is a system for applying a liquid in a field for crop plants, comprising
a control unit,
at least one storage container for holding the liquid,
at least one nozzle,
at least one collection container,
means for conveying the liquid from the at least one storage container in the direction of the at least one nozzle,
means for conveying the liquid from the at least one collection container in the direction of the at least one storage container,
at least one deflection device,
   characterized in that the control unit is configured to cause the at least deflection device to change between a first state of at least two states and a second state of the at least two states, wherein, in one of the at least two states, liquid emerging from the at least one nozzle is applied in the direction of a target object and, in the other state of the at least two states, the liquid emerging from the at least one nozzle is applied to the at least one collection container.

A further subject of the present disclosure is a method for applying a liquid in a field for crop plants, comprising the steps of:
moving a sprayer in or over the field for crop plants,
conveying a liquid from at least one storage container in the direction of at least one nozzle during movement,
changing a deflection device from a first state of at least two states to a second state of the at least two states, wherein, in one of the at least two states, liquid emerging from the at least one nozzle is applied in the direction of a target object and, in the other state of the at least two states, the liquid emerging from the at least one nozzle is applied to the at least one collection container, wherein conveying means convey the liquid from the at least one collection container into the at least one storage container.

The invention will be explained in more detail below without distinguishing between the subjects of the invention (system, method). The explanations that follow shall instead apply analogously to all subjects of the invention, regardless of the context (system, method) in which they are provided.

The present invention discloses means for applying a liquid in a field for crop plants.

The liquid may be water or an aqueous solution or suspension. The aqueous solution or suspension may contain one or more nutrients and/or one or more plant protection agents and/or one or more agents for treating seeds.

The term “nutrients” is understood as meaning those inorganic and organic compounds from which plants can extract the elements from which their bodies are formed. These elements themselves are often also referred to as nutrients. These are mostly simple inorganic compounds such as nitrate (NO³⁻), phosphate (PO₄³⁻) and potassium (K⁺). In addition to the core elements of organic matter (C, O, H, N and P), K, S, Ca, Mg, Mo, Cu, Zn, Fe, B, Mn, Cl in higher plants, Co, Ni are also vital. Different compounds can be present for the individual nutrients; for example, nitrogen can be supplied as nitrate, ammonium or amino acid.

The term “plant protection agent” is understood as meaning an agent used to protect plants or plant products from harmful organisms or prevent the effect thereof, to destroy unwanted plants or parts of plants, to inhibit unwanted growth of plants or prevent such growth, and/or to influence the life processes of plants in a way different from nutrients (e.g. growth regulators). Examples of plant protection agents are herbicides, fungicides and other pesticides (e.g. insecticides).

Growth regulators are used, for example, to increase stability in cereals by shortening the culm length (internode shorteners), improve the root development of seedlings, reduce the plant height by stunting in horticulture, or prevent the germination of potatoes. Growth regulators can be, for example, phytohormones or their synthetic analogs.

The term “field” is understood as meaning a spatially delimitable region of the surface of the earth being used for agriculture, in that such a field is planted with crop plants that are possibly supplied with nutrients and harvested.

The term “crop plant” is understood as meaning a plant which is specifically grown as a useful plant or ornamental plant by human intervention.

The liquid is applied to one or more target objects in a field for crop plants. The field or a sub-region of it is also referred to as a target area in this description.

The target object/objects can be one or more plants or parts of plants, one or more regions of a field, pests or other objects.

In one preferred embodiment, the target objects are individual crop plants or (individual) parts of individual crop plants or individual groups of crop plants.

In another preferred embodiment, the target objects are individual seeds or groups of seeds that are sown and/or have been sown in a field for crop plants.

In another preferred embodiment, the target objects are individual accompanying plants or (individual) parts of individual accompanying plants or individual groups of accompanying plants.

The term “accompanying plants” (often also referred to as weed/weeds) is understood as meaning plants of the spontaneous accompanying vegetation (segetal flora) in stands of crop plants, on grassland, or in gardens that are not being specifically grown there and develop, for example, from the seed potential of the soil or from being blown in.

In another preferred embodiment, the target objects are plant components that are infested with pests. Such pests can be animal pests, fungi, viruses or bacteria.

The liquid is in a storage container before application. There may be multiple storage containers. Multiple (different) liquids can be applied.

The liquid is applied to the target object via one or more nozzles. In one embodiment, the at least one nozzle is a component of an inkjet print head. In the embodiment, therefore, the technology used in inkjet printers is used to apply the liquid to the target object. The use of inkjet printer technology in agriculture is described, for example, in M.-Idbella et al.: Structure, Functionality, Compatibility with Pesticides and Beneficial Microbes, and Potential Applications of a New Delivery System Based on Ink-Jet Technology, Sensors 2023, 23(6), 3053.

For application, the liquid is conveyed with conveying means from the at least one storage container in the direction of the at least one nozzle. For example, a pump can be used to convey the liquid.

A deflection device ensures that liquid emerging from the at least one nozzle is applied in the direction of the target object or is applied in the direction of a collection container.

There can be a deflection device for each nozzle.

There can be a collection container for each nozzle. There can be a collection container for a group of two or more nozzles.

The deflection device can assume at least two states. In one of the at least two states, the deflection device ensures that liquid that emerges from the at least one nozzle is applied in the direction of a target object. In the other state, the deflection device ensures that liquid that emerges from the at least one nozzle is applied to the at least one collection container. The deflection device can change between the states. There may be other states.

In one preferred embodiment, there are exactly two states and the deflection device ensures that liquid emerging from the at least one nozzle is applied either in the direction of a target object (preferably to the target object) or in the direction of a collection container (preferably to the collection container).

The deflection device can be a device in which the at least one nozzle is moved. The deflection device may be, for example, a movable nozzle in combination with an actuator which moves the nozzle from a first position, in which the nozzle is aimed at a target object, to a second position, in which the nozzle is aimed at a collection container, and/or vice versa from the second position to the first position.

The deflection device may comprise, for example, a hydraulically movable piston connected to the nozzle. The hydraulics ensure that the piston moves in a piston guide. There can be two positions of the piston within the piston guide, between which it is possible to change by applying pressure from two different sides of the piston guide. The piston connected to the nozzle can transmit its movement within the piston guide to a nozzle that can also change between two positions. The nozzle can perform a translational movement and/or a rotational movement (e.g. a tilting movement). For example, the nozzle may change from a position, in which the nozzle outlet of the nozzle is aimed in the direction of a collection container, to a second position, in which the nozzle outlet of the nozzle is aimed in the direction of a target object. Instead of hydraulics, the piston can also be moved by means of a motor, e.g. a stepper motor.

The deflection device may comprise, for example, an electromagnet which holds the at least one nozzle in a first of two positions when current flows through the electromagnet, whereas, in a de-energized state of the electromagnet, a tensioned spring moves the at least one nozzle into the second of the two positions and holds it there. Once current flows through the electromagnet again, it moves the at least one nozzle into the first position and holds it there. Instead of an electromagnet in combination with a spring, it is also possible to use two electromagnets, one of which always has current flowing through it and the other of which is de-energized, in which case the electromagnet through which current flows in each case pulls the nozzle toward itself and holds it. Even in such an embodiment with one or two electromagnets, the nozzle can perform a translational and/or rotational movement.

The deflection device may comprise, for example, an air nozzle that can be used to guide an air flow in the direction of the at least one nozzle. For example, compressed air generated by a compressor can be guided from the air nozzle to the at least one nozzle. The air flow can exert an impulse on the at least one nozzle, which brings the nozzle into a defined position relative to the target object or the at least one collection container. After the air flow has been switched off, a spring can move the at least one nozzle into its starting position again. It is also possible for there to be two air nozzles, each guiding an air flow to the at least one nozzle, wherein the air nozzles use the air flow to exert an impulse on the at least one nozzle from different sides, such that the air flow from one air nozzle positions the at least one nozzle relative to the at least one collection container such that liquid emerging from the at least one nozzle is applied to the collection container, and the air flow from the other air nozzle positions the at least one nozzle relative to the target object such that liquid emerging from the at least one nozzle is applied in the direction of the target object and/or to the target object. For example, the two air nozzles can be connected to a three-way valve which ensures that air flow emerges only from one of the two air nozzles. Switching the three-way valve makes it possible to move the at least one nozzle from one position to the other. In order to avoid a permanent air flow that holds the at least one nozzle in one position, a locking mechanism may be present. The locking mechanism can ensure that the at least one nozzle brought into a defined position by the air flow remains in this position. Such a locking mechanism may comprise, for example, a hook and an eyelet, wherein one of said elements is fitted to the at least one nozzle and the other element is fitted at the position in which the at least one nozzle is intended to be held. If the air flow brings the at least one nozzle into said position, the hook can slide into the eyelet and hold the at least one nozzle in that position. There may also be a release mechanism that releases the at least one nozzle from the position in which it is held. The release mechanism can, for example, push the hook in the eyelet out of the eyelet, e.g. by means of an actuator.

The solutions described here for moving/positioning the at least one nozzle can also be combined with one another. For example, it is conceivable for one or more electromagnets to ensure that the at least one nozzle is held in one or more positions, whereas one or more air nozzles ensure that the at least one nozzle is moved from one position to another. Further/other means for positioning the at least one nozzle relative to the at least one collection container and/or the target object are also possible.

The deflection device can also be a device in which the at least one collection container is moved. Therefore, instead of moving the nozzle in relation to the collection container and positioning it such that liquid emerging from the at least one nozzle enters the collection container, the collection container can also be moved and positioned in relation to the nozzle. It is possible to use the same means for moving/positioning the collection container as those described above for moving/positioning the nozzle (a movable piston, an electromagnet in combination with a spring, two electromagnets, an air nozzle in combination with a spring, locking and/or release mechanisms, two air nozzles or combinations thereof). Likewise, the collection container can also perform a translational movement and/or a rotational movement.

Furthermore, it is possible for both the nozzle and the collection container to be caused by the deflection device to carry out a movement which positions the nozzle in a state relative to the collection container such that liquid emerging from the nozzle outlet is directed into the collection container, or alternatively positioned such that liquid emerging from the nozzle outlet is directed to a target object.

The deflection device can also be a device in which the liquid that emerges from the at least one nozzle is deflected. The liquid can be deflected, for example, by means of an air flow. For example, the air flow may be directed transversely to the direction of the liquid emerging from the nozzle (for example at an angle of 90°). In one of the at least two states, the air flow may be switched off and, in a second state of the at least two states, the air flow may be switched on and exert an impulse on the emerging liquid, which directs the emerging liquid in a defined direction.

The liquid can also be deflected, for example, by applying an electric field. The liquid can be charged electrically, e.g. when emerging from the nozzle. Without an electric field, the liquid moves in a direction predefined by the direction of gravity and the direction of the impulse of the liquid emerging from the nozzle outlet and the emerging velocity of the liquid. An electric field can then be used to deflect the electrically charged liquid in a defined direction.

It is also possible to implement a combination of the measures described here for deflecting the liquid. The deflection device described here does not offer any appreciable resistance, leading to pressure fluctuations in the supply lines to the at least one nozzle, to the liquid emerging from the nozzle outlet when changing from one state to another.

A change of the deflection device from one state to another is initiated by a control unit. The control unit may be configured to send a control signal to the deflection device, which results in a changed state (for example a change from one state to another). It is possible for the control unit to control the current flow through the electromagnet(s) or to control the hydraulics, or to control the electric field, or to turn the air flow on and off.

It is conceivable for a single control unit to control a plurality or all of the deflection devices associated with the system. It is conceivable for multiple control units to be present in the system. It is possible for each deflection device to have its own control device. Preferably, the system comprises a single control unit for controlling all the deflection devices present in the system.

Preferably, all deflection devices can be controlled independently of each other, such that, for example, one nozzle applies liquid in the direction of a target object and an adjacent nozzle simultaneously applies liquid in the direction of a collection container.

Preferably, the control unit is connected to one or more sensor units.

A sensor unit comprises at least one sensor.

A “sensor” is a technical component that is able to capture certain physical and/or chemical properties and/or the material nature of its surroundings in a qualitative manner, or in a quantitative manner as a measured variable. These variables are captured by means of physical or chemical effects and transformed into a signal that can be processed further, usually an electrical or optical signal.

A sensor unit may contain means for processing signals provided by the at least one sensor. A sensor unit may comprise means for transmitting and/or forwarding signals and/or information (e.g. to the control unit).

The one or more sensor units can be part of the system and/or connected to the latter via a communication connection (e.g. via radio).

The one or more sensor units may be configured to transmit one or more signals to the control unit continuously or at defined intervals of time or upon the occurrence of defined events, on the basis of which signals the control unit controls the at least one deflection device.

The at least one sensor unit may comprise, for example, a receiver of a satellite navigation system, colloquially also referred to as a GPS receiver. The Global Positioning System (abbreviated to: GPS), officially NAVSTAR GPS, is an example of a global satellite navigation system for positioning; other examples are GLONASS, Galileo and Beidou. The satellites of such a satellite navigation system communicate their exact position and time via radio codes. For positioning, a receiver (the “GPS receiver”) must receive the signals from at least four satellites at the same time. In the receiver, the pseudo-signal propagation times are measured and used to determine the current position.

In a similar manner to that described in US20220117151A1, the sensor unit comprising a receiver of a satellite navigation system may be configured to transmit information about the position of the system or the position of individual nozzles in a field for crop plants to the control unit. The control unit may be configured to use the position information to determine information about a requirement for the application of a liquid from a field map. For example, the field map may record the positions in the field at which a liquid is and/or is not to be applied. The control unit may be configured to control the deflection device according to the information determined: at positions in the field at which liquid is to be applied, the control unit can cause the deflection device to apply the liquid emerging from the at least one nozzle in the direction of a target object; at positions in the field at which no liquid is to be applied, the control unit can cause the deflection device to apply the liquid emerging from the at least one nozzle in the direction of a collection container.

The at least one sensor unit can comprise one or more cameras. Such a camera may comprise an image sensor and optical elements. The image sensor is an apparatus for recording two-dimensional images from light by electrical means. It typically comprises semiconductor-based image sensors, for example CCD (CCD=charge-coupled device) or CMOS sensors (CMOS=complementary metal-oxide-semiconductor). The optical elements (lenses, stops and the like) serve for maximum sharpness of imaging of an object on the image sensor.

The camera can be caused by a control unit to produce image recordings of the field, the soil of the field, crop plants, accompanying plants and/or pests at defined intervals of time or continuously. The control unit may be the control unit of the system according to the invention or a separate control unit. The control unit may be part of the camera or of the system according to the invention or a separate apparatus.

The image recordings produced can be transmitted to an analysis unit. The analysis unit can be configured to analyze the image recordings produced in order to recognize defined objects in the image recordings, e.g. a defined plant (e.g. an accompanying plant) and/or a part of a defined plant (e.g. a leaf) and/or a pest and/or a pest-infested plant and/or a pest-infested part of a plant or another object. Methods and apparatuses for recognizing objects in image recordings are described in a variety of ways in the prior art (see for example: WO2020120802A1, WO2020120804A1, WO2020229585A1).

The analysis unit may be part of the camera and/or part of the system according to the invention. The analysis unit may be configured to transmit a recognition signal to the control unit of the system according to the invention when the analysis unit has identified a specific object in an image recording. The control unit may be configured, in response to the recognition signal, to send a control signal to the at least one deflection device, which causes the at least one deflection device to change state, for example to apply liquid emerging from the at least one nozzle in the direction of the specific object.

The system according to the invention can be part of a sprayer, for example an agricultural machine, a robot, or an aircraft (e.g. a drone) or be connectable thereto. Such a sprayer can move autonomously in or over a field or be controlled by a person.

Preferably, the system according to the invention comprises a multiplicity of nozzles and deflection devices. The term “multiplicity” preferably means more than ten. The nozzles are preferably arranged such that each nozzle applies liquid in a region with a maximum lateral extent of less than 20 cm, preferably less than 10 cm, most preferably less than 5 cm.

The multiplicity of nozzles may be arranged, for example, side by side along a spray bar that extends transversely (e.g. at an angle of 90°) to the direction of movement of the sprayer.

Embodiments of the present invention are:

1: A system for applying a liquid in a field for crop plants, comprising
a control unit,
at least one storage container for holding a liquid,
at least one nozzle,
at least one collection container, means for conveying the liquid from the at least one storage container in the direction of the at least one nozzle,
means for conveying the liquid from the at least one collection container in the direction of the at least one storage container,
at least one deflection device,
   characterized in that the control unit is configured to cause the at least deflection device to change between a first state of at least two states and a second state of the at least two states, wherein, in one of the at least two states, liquid emerging from the at least one nozzle is applied in the direction of a target object and, in the other state of the at least two states, the liquid emerging from the at least one nozzle is applied in the direction of the at least one collection container.

2: The system according to embodiment 1, wherein the at least one nozzle is movable, wherein the deflection device is prepared to move the at least one nozzle from a first position to a second position.

3: The system according to embodiment 1 or 2, wherein the at least one nozzle is tiltable between two positions.

4: The system according to one of embodiments 1 to 3, wherein the at least one collection container is movable, wherein the at least one deflection device is prepared to move the at least one collection container from a first position to a second position.

5: The system according to one of embodiments 1 to 4, wherein the at least one collection container is tiltable between two positions.

6: The system according to one of embodiments 1 to 5, wherein the at least one deflection device is prepared to deflect liquid emerging from the at least one nozzle by means of an electric field and/or an impulse.

7: The system according to one of embodiments 1 to 6, wherein the at least one deflection device comprises at least one electromagnet which moves and/or holds the at least one nozzle and/or the at least one collection container into/in a defined position when current flows through the electromagnet, and/or comprises at least one air nozzle which moves the at least one nozzle and/or the at least one collection container into a defined position by means of an air flow.

8: The system according to one of embodiments 1 to 7, wherein the control unit is configured to receive a recognition signal from a sensor unit and to control the at least one deflection device depending on the recognition signal.

9: The system according to one of embodiments 1 to 8, wherein the system is a part of an agricultural machine, a robot or a drone, or is connectable thereto.

10: The system according to one of embodiments 1 to 9, comprising a multiplicity of nozzles, wherein the nozzles are arranged such that each nozzle sprays liquid on a region having a maximum lateral extent of less than 10 cm.

11: The system according to one of embodiments 1 to 10, further comprising a sensor unit, wherein the sensor unit comprises a camera and an analysis unit, wherein the camera is configured to produce image recordings of a target area, wherein the analysis unit is configured to analyze the image recordings, to recognize a specific target object and to transmit a recognition signal to the control unit, wherein the control unit is configured to cause the at least one deflection device, in response to the transmission of the recognition signal, to direct liquid emerging from the at least one nozzle in the direction of the specific target object.

12: A method for applying a liquid in a field for crop plants, comprising the steps of:
moving a sprayer in or over the field for crop plants,
conveying a liquid from at least one storage container in the direction of at least one nozzle during movement,
changing a deflection device from a first state of at least two states to a second state of the at least two states, wherein, in one of the at least two states, liquid emerging from the at least one nozzle is applied in the direction of a target object and, in the other state of the at least two states, the liquid emerging from the at least one nozzle is applied in the direction of least one collection container, wherein conveying means convey the liquid from the at least one collection container into the at least one storage container.

13: The method according to embodiment 12, wherein the liquid comprises one or more nutrients and/or one or more plant protection agents and/or one or more agents for treating seeds.

14: The method according to embodiment 12 or 13, wherein the target object is a plant or a group of plants or a part of a plant or multiple parts of a plant.

15: The method according to one of embodiments 12 to 14, comprising the steps of:
moving the sprayer in or over the field for crop plants,
conveying the liquid from the at least one storage container in the direction of the at least one nozzle during movement,
receiving a signal for the presence of a specific target object,
changing the deflection device from the first state to the second state, wherein the first state applies the liquid emerging from the at least one nozzle in the direction of the at least one collection container and the second state applies the liquid emerging from the at least one nozzle in the direction of the specific target object.

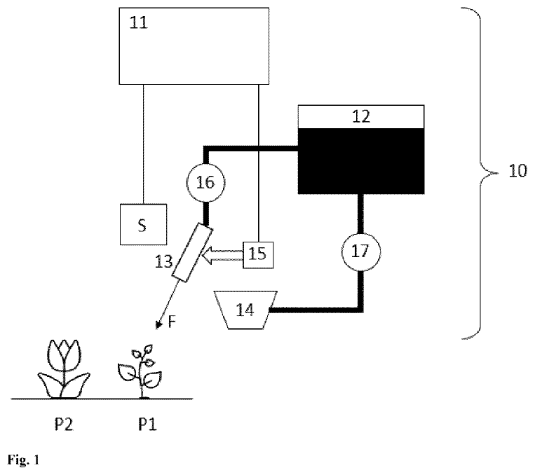

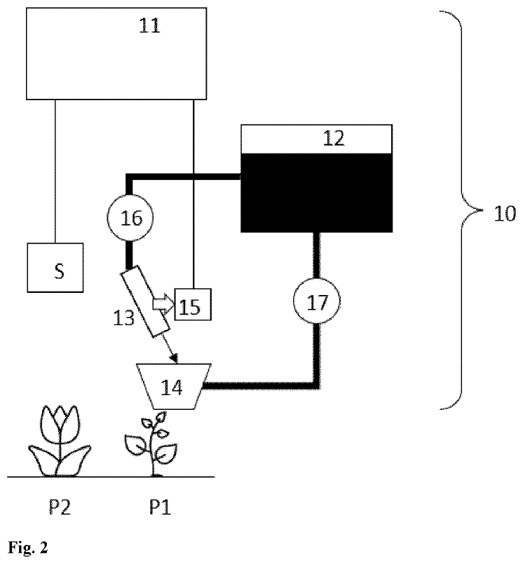

FIG. 1 and FIG. 2 show, by way of example and in schematic form, an embodiment of the system according to the invention.

The system (10) comprises a control unit (11), a storage container (12), a nozzle (13), a collection container (14), a deflection device (15), means (16) for conveying a liquid (F) from the storage container (12) in the direction of the nozzle (13) and means (17) for conveying the liquid (F) from the collection container (14) in the direction of the storage container (12).

FIGS. 1 and 2 also illustrate a sensor unit (S) which is connected to the control unit (11). The sensor unit (S) can be a component of the system (10) according to the invention or a separate apparatus. The sensor unit (S) recognizes in FIG. 1 an accompanying plant (P1), which is located below the sensor unit (S), and transmits a recognition signal to the control unit (11). The control unit (11) causes the deflection device (15) to apply the liquid (F) emerging from the nozzle (13) in the direction of the accompanying plant (P1). The accompanying plant (P1) is the target object in the present example. In FIG. 2, the system (10) has moved with respect to the accompanying plant (P1) and an adjacent crop plant (P2) in the direction of the adjacent crop plant (P2) (to the left in FIG. 2). The sensor unit (S) now recognizes a crop plant (P2) and transmits a recognition signal to the control unit (11). The control unit (11) causes the deflection device (15) to apply the liquid (F) emerging from the nozzle (13) in the direction of the collection container (14).

1. A system for applying a liquid in a field for crop plants, comprising:
a control unit;
at least one storage container for holding the liquid;
at least one nozzle;
at least one collection container;
means for conveying the liquid from the at least one storage container in the direction of the at least one nozzle;
means for conveying the liquid from the at least one collection container in the direction of the at least one storage container; and
at least one deflection device;
wherein the control unit is configured to cause the at least deflection device to change between a first state of at least two states and a second state of the at least two states, wherein, in one of the at least two states, liquid emerging from the at least one nozzle is applied in the direction of a target object and, in the other state of the at least two states, the liquid emerging from the at least one nozzle is applied in the direction of the at least one collection container,
characterized in that the deflection device comprises at least one air nozzle, wherein the at least one air nozzle is oriented such that an air flow emerging from the at least one air nozzle changes the deflection device from the first state to the second state and/or from the second state to the first state.

2. The system as claimed in claim 1, wherein the at least one nozzle is movable, wherein the air flow moves the at least one nozzle from a first position to a second position.

3. The system as claimed in claim 2, wherein the at least one nozzle is tiltable between two positions.

4. The system as claimed in claim 1, wherein the at least one collection container is movable, wherein the air flow moves the at least one collection container from a first position to a second position.

5. The system as claimed in claim 4, wherein the at least one collection container is tiltable between two positions.

6. The system as claimed in claim 1, wherein the air flow deflects the liquid emerging from the at least one nozzle in the direction of the at least one collection container.

7. The system as claimed in claim 1, wherein the control unit is configured to receive a recognition signal from a sensor unit and to control the at least one deflection device depending on the recognition signal.

8. The system as claimed in claim 1, wherein the system is a part of an agricultural machine, a robot or a drone, or is connectable thereto.

9. The system as claimed in claim 1, comprising a multiplicity of nozzles, wherein the nozzles are arranged such that each nozzle sprays liquid on a region having a maximum lateral extent of less than 10 cm.

10. The system as claimed in claim 1, further comprising a sensor unit, wherein the sensor unit comprises a camera and an analysis unit, wherein the camera is configured to produce image recordings of a target area, wherein the analysis unit is configured to analyze the image recordings, to recognize a specific target object and to transmit a recognition signal to the control unit, wherein the control unit is configured to cause the at least one deflection device, in response to the transmission of the recognition signal, to direct liquid emerging from the at least one nozzle in the direction of the specific target object.

11. The system as claimed in claim 10, wherein the at least one nozzle is a component of an inkjet print head.

12. A method for applying a liquid in a field for crop plants, comprising the steps of:
moving a sprayer in or over the field for crop plants;
conveying the liquid from at least one storage container in the direction of at least one nozzle during movement; and
changing a deflection device from a first state of at least two states to a second state of the at least two states, wherein, in one of the at least two states, liquid emerging from the at least one nozzle is applied in the direction of a target object and, in the other state of the at least two states, the liquid emerging from the at least one nozzle is applied in the direction of least one collection container, wherein conveying means convey the liquid from the at least one collection container into the at least one storage container;
characterized in that the deflection device comprises at least one air nozzle, wherein the at least one air nozzle is oriented such that an air flow emerging from the at least one air nozzle changes the deflection device from the first state to the second state and/or from the second state to the first state.

13. The method as claimed in claim 12, wherein the liquid comprises one or more nutrients and/or one or more plant protection agents and/or one or more agents for treating seeds.

14. The method as claimed in claim 12, wherein the target object is a plant or a group of plants or a part of a plant or multiple parts of a plant.

15. The method as claimed in claim 12, comprising the steps of:
moving the sprayer in or over the field for crop plants;
conveying the liquid from the at least one storage container in the direction of the at least one nozzle during movement;
receiving a signal for the presence of a specific target object; and
changing the deflection device from the first state to the second state, wherein the first state applies the liquid emerging from the at least one nozzle in the direction of the at least one collection container and the second state applies the liquid emerging from the at least one nozzle in the direction of the specific target object.
